(19) United States
(12) Patent Application Publication
(10) Pub. No.: US 2026/0065918 A1
(43) Pub. Date: Mar. 5, 2026

(54) METHOD AND APPARATUS FOR TRAINING AND USING A MICROPHONE GEOMETRY ASSISTED ENCODER MODEL TO GENERATE SPATIAL AUDIO SIGNALS TECHNOLOGICAL FIELD

(71) Applicant: Nokia Technologies Oy, Espoo (FI)

(72) Inventors: Mikko Olavi HEIKKINEN, Tampere (FI); Konstantinos DROSOS, Espoo (FI); Tuomas VIRTANEN, Tampere (FI); Archontis POLITIS, Tampere (FI)

(21) Appl. No.: 19/312,521

(22) Filed: Aug. 28, 2025

Related U.S. Application Data
(60) Provisional application No. 63/690,942, filed on Sep. 5, 2024.

(51) Int. Cl. G10L 19/008; H04R 1/32; H04R 3/00

(52) U.S. Cl. CPC G10L 19/008; H04R 1/326; H04R 3/005

(57) ABSTRACT

A system for training a microphone geometry assisted encoder model and then utilizing the trained model to generate spatial audio signals that have been captured by a plurality of microphones. In a method for generating spatial audio signals, the method includes receiving geometry data related to a plurality of microphones of an audio capturing device and audio signal data captured by the plurality of microphones. The method also includes generating a spatial audio signal based on an output of a trained microphone geometry assisted encoder model. The trained microphone geometry assisted encoder model includes a geometry encoder configured to encode the geometry data and a signal encoder configured to encode the audio signal data. The trained microphone geometry assisted encoder model further includes a signal decoder having a plurality of layers and configured to generate the output upon which the spatial audio signal is based.

### TECHNOLOGICAL FIELD

An example embodiment relates generally to spatial audio capture and, more particularly, to a method and apparatus for training and using a microphone geometry assisted encoder model to generate spatial audio signals.

### BACKGROUND

Spatial audio capture advantageously represents a sound field in a more realistic manner. In this regard, spatial audio capture records a sound field in such a manner that subsequent reproduction of the spatial audio signals results in a listener perceiving the sound field in a three-dimensional space. Spatial audio capture therefore creates the impression that sounds originate from different directions and distances in the same manner in which the sounds were originally captured in order to provide for an immersive and realistic auditory experience. Techniques for capturing spatial audio signals can be based on capturing the physical properties of the sound field, or at least features of the sound field that are most relevant for human spatial auditory perception.

Spatial audio may be represented in various manners. For example, Ambisonics is a format that describes an incident sound field at a reference point as a multi-channel decomposition of audio signals based on spherical harmonics. Additionally, immersive voice and audio services (IVAS) metadata-assisted spatial audio (MASA) as defined by the 3GPP IVAS standard can also be utilized to represent spatial audio signals. IVAS MASA is based on a set of source signals and a parametric representation of spatial features that are relevant for human hearing. IVAS is utilized for immersive communication audio and defines a codec for encoding and decoding audio signals and settings that enable various immersive communication scenarios. Spatial audio representations can be rendered in various formats, such as 5.1 for output by multichannel loudspeakers or binaural formats for spatial headphone applications.

### BRIEF SUMMARY

A method, apparatus and computer program product are provided for training a microphone geometry assisted encoder model and then utilizing the trained microphone geometry assisted encoder model to generate spatial audio signals that have been captured by a plurality of microphones of an audio capturing device. By utilizing a microphone geometry assisted encoder model having both a geometry encoder and a signal encoder as well as a signal decoder, the method, apparatus and computer program product may accurately and efficiently generate spatial audio signals based on audio signal data captured by audio capturing devices having different microphone arrays with different geometries in a manner that does not require time and effort otherwise expended to re-tune the model. Moreover, the method, apparatus and computer program product of an example embodiment are adaptable to generate spatial audio signals using the microphone geometry assisted encoder model based on spatial audio data captured by different types of microphone arrays for which only limited geometry data is known in advance. As such, the method, apparatus and computer program product of an example embodiment readily and efficiently generate spatial audio signals from audio signal data captured by different audio capturing devices with different microphone arrays having different geometries without the cost and time delays associated with retraining of the microphone geometry assisted encoder model, even in instances in which only limited geometry data regarding the microphone arrays is known.

In an example embodiment, an apparatus is provided that includes at least one processor and at least one memory storing instructions that, when executed by the at least one processor, cause the apparatus at least to receive geometry data related to a plurality of microphones of an audio capturing device and audio signal data captured by the plurality of microphones. The instructions, when executed by the at least one processor, also cause the apparatus to generate a spatial audio signal based on an output of a trained microphone geometry assisted encoder model. The trained microphone geometry assisted encoder model includes a geometry encoder configured to encode the geometry data and a signal encoder configured to encode the audio signal data. The geometry encoder and the signal encoder respectively include a plurality of layers and the trained microphone geometry assisted encoder model also includes a plurality of connection links configured to connect respective layers of the geometry encoder and the signal encoder such that the signal encoder is configured to process both geometric data and audio signal data. The trained microphone geometry assisted encoder model further includes a signal decoder having a plurality of layers and configured to generate the output upon which the spatial audio signal is based, a plurality of connection links configured to connect respective layers of the signal encoder and the signal decoder, and a bottleneck connector between the signal encoder and the signal decoder.

The instructions, when executed by the at least one processor, cause the apparatus of an example embodiment to generate the spatial audio signal based on the output of the trained microphone geometry assisted encoder model by generating a predicted filter matrix with the trained microphone geometry assisted encoder model and convolving a representation of the audio signal data with the predicted filter matrix to generate the spatial audio signal. In this embodiment, the instructions, when executed by the at least one processor, cause the apparatus to convolve the representation of the audio signal data with the predicted filter matrix by convolving the representation of the audio signal data with a plurality of respective elements of the predicted filter matrix and summing results of the convolving of the representation of the audio signal data with the plurality of respective elements of the predicted filter matrix to generate the spatial audio signal. The instructions, when executed by the at least one processor, may further cause the apparatus to convert the audio signal data from a time domain to a frequency domain prior to provision of the audio signal data to the trained microphone geometry assisted encoder model and prior to convolution with the predicted filter matrix.

The trained microphone geometry assisted encoder model of an example embodiment is a U-net model. The geometry data may include a number of microphones and a location of respective microphones of the plurality of microphones. In an example embodiment, the geometry data further includes information regarding directional magnitude and phase responses of audio signals captured by the plurality of microphones. A respective layer of the geometry encoder of an example embodiment includes a strided two dimensional (2D) convolution operation. In an example embodiment, a respective layer of the signal encoder includes at least two convolution operations with a respective convolution operation followed by a non-linear activation function. The respective layer of the signal encoder further includes a dropout function to generate a signal output from the respective layer. A respective layer of the signal decoder of an example embodiment includes at least two convolution operations with a respective convolution operation followed by a non-linear activation function. In an example embodiment, the instructions, when executed by the at least one processor, further cause the apparatus to increase dimensionality of the geometry data prior to provision to the geometry encoder.

In another embodiment, a method is provided that includes receiving geometry data related to a plurality of microphones of an audio capturing device and audio signal data captured by the plurality of microphones. The method further includes generating a spatial audio signal based on an output of a trained microphone geometry assisted encoder model. The trained microphone geometry assisted encoder model includes a geometry encoder configured to encode the geometry data and a signal encoder configured to encode the audio signal data. The geometry encoder and the signal encoder respectively include a plurality of layers and the trained microphone geometry assisted encoder model also includes a plurality of connection links configured to connect respective layers of the geometry encoder and the signal encoder such that the signal encoder is configured to process both geometric data and audio signal data. The trained microphone geometry assisted encoder model further includes a signal decoder having a plurality of layers and configured to generate the output upon which the spatial audio signal is based, a plurality of connection links configured to connect respective layers of the signal encoder and the signal decoder, and a bottleneck connector between the signal encoder and the signal decoder.

Generating the spatial audio signal based on the output of the trained microphone geometry assisted encoder model may include generating a predicted filter matrix with the trained microphone geometry assisted encoder model and convolving a representation of the audio signal data with the predicted filter matrix to generate the spatial audio signal. In this embodiment, convolving the representation of the audio signal data with the predicted filter matrix may include convolving the representation of the audio signal data with a plurality of respective elements of the predicted filter matrix and summing results of the convolving of the representation of the audio signal data with the plurality of respective elements of the predicted filter matrix to generate the spatial audio signal. The method of an example embodiment also includes converting the audio signal data from a time domain to a frequency domain prior to provision of the audio signal data to the trained microphone geometry assisted encoder model and prior to convolution with the predicted filter matrix.

The trained microphone geometry assisted encoder model of an example embodiment includes a U-net model. In an example embodiment, the geometry data may include a number of microphones and a location of respective microphones of the plurality of microphones. The geometry data may also include information regarding directional magnitude and phase responses of audio signals captured by the plurality of microphones. A respective layer of the geometry encoder may include a strided two dimensional (2D) convolution operation. In an example embodiment, a respective layer of the signal encoder includes at least two convolution operations with a respective convolution operation followed by a non-linear activation function. The respective layer of the signal encoder of this example embodiment further includes a dropout function to generate a signal output from the respective layer. In an example embodiment, a respective layer of the signal decoder includes at least two convolution operations with a respective convolution operation followed by a non-linear activation function. The method of an example embodiment, further includes increasing dimensionality of the geometry data prior to provision to the geometry encoder.

In another embodiment, a method is provided that includes receiving geometry data related to a plurality of microphones of an audio capturing device and audio signal data captured by the plurality of microphones. The method further includes generating a spatial audio signal based on an output of a trained microphone geometry assisted encoder model. The trained microphone geometry assisted encoder model includes a geometry encoder configured to encode the geometry data and a signal encoder configured to encode the audio signal data. The geometry encoder and the signal encoder respectively include a plurality of layers and the trained microphone geometry assisted encoder model also includes a plurality of connection links configured to connect respective layers of the geometry encoder and the signal encoder such that the signal encoder is configured to process both geometric data and audio signal data. The trained microphone geometry assisted encoder model further includes a signal decoder having a plurality of layers and configured to generate the output upon which the spatial audio signal is based, a plurality of connection links configured to connect respective layers of the signal encoder and the signal decoder, and a bottleneck connector between the signal encoder and the signal decoder.

Generating the spatial audio signal based on the output of the trained microphone geometry assisted encoder model may include generating a predicted filter matrix with the trained microphone geometry assisted encoder model and convolving a representation of the audio signal data with the predicted filter matrix to generate the spatial audio signal. In this embodiment, convolving the representation of the audio signal data with the predicted filter matrix may include convolving the representation of the audio signal data with a plurality of respective elements of the predicted filter matrix and summing results of the convolving of the representation of the audio signal data with the plurality of respective elements of the predicted filter matrix to generate the spatial audio signal. The method of an example embodiment also includes converting the audio signal data from a time domain to a frequency domain prior to provision of the audio signal data to the trained microphone geometry assisted encoder model and prior to convolution with the predicted filter matrix.

The trained microphone geometry assisted encoder model of an example embodiment includes a U-net model. In an example embodiment, the geometry data may include a number of microphones and a location of respective microphones of the plurality of microphones. The geometry data may also include information regarding directional magnitude and phase responses of audio signals captured by the plurality of microphones. A respective layer of the geometry encoder may include a strided two dimensional (2D) convolution operation. In an example embodiment, a respective layer of the signal encoder includes at least two convolution operations with a respective convolution operation followed by a non-linear activation function. The respective layer of the signal encoder of this example embodiment further includes a dropout function to generate a signal output from the respective layer. In an example embodiment, a respective layer of the signal decoder includes at least two convolution operations with a respective convolution operation followed by a non-linear activation function. The method of an example embodiment further includes increasing dimensionality of the geometry data prior to provision to the geometry encoder.

In a further embodiment, a non-transitory computer readable storage medium is provided that includes computer instructions that, when executed by an apparatus, cause the apparatus to receive geometry data related to a plurality of microphones of an audio capturing device and audio signal data captured by the plurality of microphones. The computer instructions, when executed by the apparatus, also cause the apparatus to generate a spatial audio signal based on an output of a trained microphone geometry assisted encoder model. The trained microphone geometry assisted encoder model includes a geometry encoder configured to encode the geometry data and a signal encoder configured to encode the audio signal data. The geometry encoder and the signal encoder respectively include a plurality of layers and the trained microphone geometry assisted encoder model also includes a plurality of connection links configured to connect respective layers of the geometry encoder and the signal encoder such that the signal encoder is configured to process both geometric data and audio signal data. The trained microphone geometry assisted encoder model further includes a signal decoder having a plurality of layers and configured to generate the output upon which the spatial audio signal is based, a plurality of connection links configured to connect respective layers of the signal encoder and the signal decoder, and a bottleneck connector between the signal encoder and the signal decoder.

The instructions that cause the apparatus to generate the spatial audio signal based on the output of the trained microphone geometry assisted encoder model may include instructions that cause the apparatus to generate a predicted filter matrix with the trained microphone geometry assisted encoder model and convolve a representation of the audio signal data with the predicted filter matrix to generate the spatial audio signal. In this embodiment, instructions that cause the apparatus to convolve the representation of the audio signal data with the predicted filter matrix may include instructions that cause the apparatus to convolve the representation of the audio signal data with a plurality of respective elements of the predicted filter matrix and sum results of the convolving of the representation of the audio signal data with the plurality of respective elements of the predicted filter matrix to generate the spatial audio signal. The instructions also cause the apparatus of an example embodiment to convert the audio signal data from a time domain to a frequency domain prior to provision of the audio signal data to the trained microphone geometry assisted encoder model and prior to convolution with the predicted filter matrix.

The trained microphone geometry assisted encoder model of an example embodiment includes a U-net model. In an example embodiment, the geometry data may include a number of microphones and a location of respective microphones of the plurality of microphones. The geometry data may also include information regarding directional magnitude and phase responses of audio signals captured by the plurality of microphones. A respective layer of the geometry encoder may include a strided two dimensional (2D) convolution operation. In an example embodiment, a respective layer of the signal encoder includes at least two convolution operations with a respective convolution operation followed by a non-linear activation function. The respective layer of the signal encoder of this example embodiment further includes a dropout function to generate a signal output from the respective layer. In an example embodiment, a respective layer of the signal decoder includes at least two convolution operations with a respective convolution operation followed by a non-linear activation function. The instructions also cause the apparatus of an example embodiment to increase dimensionality of the geometry data prior to provision to the geometry encoder.

In yet another embodiment, an apparatus is provided that includes means for receiving geometry data related to a plurality of microphones of an audio capturing device and audio signal data captured by the plurality of microphones. The apparatus further includes means for generating a spatial audio signal based on an output of a trained microphone geometry assisted encoder model. The trained microphone geometry assisted encoder model includes a geometry encoder configured to encode the geometry data and a signal encoder configured to encode the audio signal data. The geometry encoder and the signal encoder respectively include a plurality of layers and the trained microphone geometry assisted encoder model also includes a plurality of connection links configured to connect respective layers of the geometry encoder and the signal encoder such that the signal encoder is configured to process both geometric data and audio signal data. The trained microphone geometry assisted encoder model further includes a signal decoder having a plurality of layers and configured to generate the output upon which the spatial audio signal is based, a plurality of connection links configured to connect respective layers of the signal encoder and the signal decoder, and a bottleneck connector between the signal encoder and the signal decoder.

The means for generating the spatial audio signal based on the output of the trained microphone geometry assisted encoder model may include means for generating a predicted filter matrix with the trained microphone geometry assisted encoder model and means for convolving a representation of the audio signal data with the predicted filter matrix to generate the spatial audio signal. In this embodiment, the means for convolving the representation of the audio signal data with the predicted filter matrix may include means for convolving the representation of the audio signal data with a plurality of respective elements of the predicted filter matrix and means for summing results of the convolving of the representation of the audio signal data with the plurality of respective elements of the predicted filter matrix to generate the spatial audio signal. The apparatus of an example embodiment also includes means for converting the audio signal data from a time domain to a frequency domain prior to provision of the audio signal data to the trained microphone geometry assisted encoder model and prior to convolution with the predicted filter matrix.

The trained microphone geometry assisted encoder model of an example embodiment includes a U-net model. In an example embodiment, the geometry data may include a number of microphones and a location of respective microphones of the plurality of microphones. The geometry data may also include information regarding directional magnitude and phase responses of audio signals captured by the plurality of microphones. A respective layer of the geometry encoder may include a strided two dimensional (2D) convolution operation. In an example embodiment, a respective layer of the signal encoder includes at least two convolution operations with a respective convolution operation followed by a non-linear activation function. The respective layer of the signal encoder of this example embodiment further includes a dropout function to generate a signal output from the respective layer. In an example embodiment, a respective layer of the signal decoder includes at least two convolution operations with a respective convolution operation followed by a non-linear activation function. The apparatus of an example embodiment further includes means for increasing dimensionality of the geometry data prior to provision to the geometry encoder.

In an example embodiment, an apparatus is provided that includes at least one processor and at least one memory storing instructions that, when executed by the at least one processor, cause the apparatus at least to provide geometry data related to a plurality of microphones of a microphone array and audio signal data to a microphone geometry assisted encoder model. The microphone geometry assisted encoder model includes a geometry encoder configured to encode the geometry data and a signal encoder configured to encode the audio signal data. The geometry encoder and the signal encoder respectively include a plurality of layers and the microphone geometry assisted encoder model also includes a plurality of connection links configured to connect respective layers of the geometry encoder and the signal encoder such that the signal encoder is configured to process both geometric data and audio signal data. The microphone geometry assisted encoder model further includes a signal decoder having a plurality of layers and configured to generate an output, a plurality of connection links configured to connect respective layers of the signal encoder and the signal decoder, and a bottleneck connector between the signal encoder and the signal decoder. The instructions, when executed by the at least one processor, also cause the apparatus to generate a predicted spatial audio signal based on the output of the microphone geometry assisted encoder model, perform a comparison of the predicted spatial audio signal with a representation of a reference audio signal and train the microphone geometry assisted encoder model by modifying the microphone geometry assisted encoder model based upon the comparison.

The instructions, when executed by the at least one processor, cause the apparatus of an example embodiment to generate the predicted spatial audio signal by generating a predicted filter matrix with the microphone geometry assisted encoder model and convolving a representation of the audio signal data with the predicted filter matrix to generate the predicted spatial audio signal. In this embodiment, the instructions, when executed by the at least one processor, may cause the apparatus to convolve the representation of the audio signal data with the predicted filter matrix by convolving the representation of the audio signal data with a plurality of respective elements of the predicted filter matrix and summing results of the convolving of the representation of the audio signal data with the plurality of respective elements of the predicted filter matrix to generate the predicted spatial audio signal. The instructions, when executed by the at least one processor, may further cause the apparatus to generate a simulated audio signal data for respective ones of a plurality of combinations of audio scenes and microphone arrays and generate a simulated reference audio signal for respective ones of the plurality of combinations of audio scenes and microphone arrays. In this embodiment, the instructions, when executed by the at least one processor, may further cause the apparatus to repeatedly provide geometry data and audio signal data to the microphone geometry assisted encoder model, generate the predicted filter matrix, convolve the representation of the audio signal data with the predicted filter matrix, perform the comparison and train the microphone geometry assisted encoder model by using different simulated audio signal data and different simulated reference audio signals for the audio signal data and the reference audio signal, respectively.

The microphone geometry assisted encoder model may include a U-net model. In an example embodiment, the geometry data includes a number of microphones and a location of respective microphones of the plurality of microphones. The instructions, when executed by the at least one processor, may also cause the apparatus to convert the audio signal data from a time domain to a frequency domain prior to provision of the audio signal data to the microphone geometry assisted encoder model and prior to convolution with the predicted filter matrix. In an example embodiment, the instructions, when executed by the at least one processor, may also cause the apparatus to increase dimensionality of the geometry data prior to provision to the geometry encoder.

In another example embodiment, a method is provided that includes providing geometry data related to a plurality of microphones of a microphone array and audio signal data to a microphone geometry assisted encoder model. The microphone geometry assisted encoder model includes a geometry encoder configured to encode the geometry data and a signal encoder configured to encode the audio signal data. The geometry encoder and the signal encoder respectively include a plurality of layers and the microphone geometry assisted encoder model also includes a plurality of connection links configured to connect respective layers of the geometry encoder and the signal encoder such that the signal encoder is configured to process both geometric data and audio signal data. The microphone geometry assisted encoder model further includes a signal decoder having a plurality of layers and configured to generate an output, a plurality of connection links configured to connect respective layers of the signal encoder and the signal decoder, and a bottleneck connector between the signal encoder and the signal decoder. The method also includes generating a predicted spatial audio signal based on the output of the microphone geometry assisted encoder model and performing a comparison of the predicted spatial audio signal with a representation of a reference audio signal. The method further includes training the microphone geometry assisted encoder model by modifying the microphone geometry assisted encoder model based upon the comparison.

The method of an example embodiment generates the predicted spatial audio signal by generating a predicted filter matrix with the microphone geometry assisted encoder model and convolving a representation of the audio signal data with the predicted filter matrix to generate the predicted spatial audio signal. In this embodiment, the method convolves the representation of the audio signal data with the predicted filter matrix by convolving the representation of the audio signal data with a plurality of respective elements of the predicted filter matrix and summing results of the convolving of the representation of the audio signal data with the plurality of respective elements of the predicted filter matrix to generate the predicted spatial audio signal. In an example embodiment, the method further includes generating a simulated audio signal data for respective ones of a plurality of combinations of audio scenes and microphone arrays and generating a simulated reference audio signal for respective ones of the plurality of combinations of audio scenes and microphone arrays. The method of this example embodiment may repeatedly provide geometry data and audio signal data to the microphone geometry assisted encoder model, generate the predicted filter matrix, convolve the representation of the audio signal data with the predicted filter matrix, perform the comparison and train the microphone geometry assisted encoder model by using different simulated audio signal data and different simulated reference audio signals for the audio signal data and the reference audio signal, respectively.

The microphone geometry assisted encoder model may include a U-net model. The geometry data of an example embodiment may include a number of microphones and a location of respective microphones of the plurality of microphones. In an example embodiment, the method also includes converting the audio signal data from a time domain to a frequency domain prior to provision of the audio signal data to the microphone geometry assisted encoder model and prior to convolution with the predicted filter matrix. The method of an example embodiment further includes increasing dimensionality of the geometry data prior to provision to the geometry encoder.

In further embodiment, a non-transitory computer readable storage medium is provided that includes computer instructions that, when executed by an apparatus, cause the apparatus to provide geometry data related to a plurality of microphones of a microphone array and audio signal data to a microphone geometry assisted encoder model. The microphone geometry assisted encoder model includes a geometry encoder configured to encode the geometry data and a signal encoder configured to encode the audio signal data. The geometry encoder and the signal encoder respectively include a plurality of layers and the microphone geometry assisted encoder model also includes a plurality of connection links configured to connect respective layers of the geometry encoder and the signal encoder such that the signal encoder is configured to process both geometric data and audio signal data. The microphone geometry assisted encoder model further includes a signal decoder having a plurality of layers and configured to generate an output, a plurality of connection links configured to connect respective layers of the signal encoder and the signal decoder, and a bottleneck connector between the signal encoder and the signal decoder. The instructions, when executed by the apparatus, also cause the apparatus to generate a predicted spatial audio signal based on the output of the microphone geometry assisted encoder model and perform a comparison of the predicted spatial audio signal with a representation of a reference audio signal. The instructions, when executed by the apparatus, further cause the apparatus to train the microphone geometry assisted encoder model by modifying the microphone geometry assisted encoder model based upon the comparison.

The instructions that cause the apparatus of an example embodiment to generate the predicted spatial audio signal include instructions that, when executed by the apparatus, cause the apparatus to generate a predicted filter matrix with the microphone geometry assisted encoder model and convolve a representation of the audio signal data with the predicted filter matrix to generate the predicted spatial audio signal. In this embodiment, the instructions that cause the apparatus to convolve the representation of the audio signal data with the predicted filter matrix include instructions that, when executed by the apparatus, cause the apparatus to convolve the representation of the audio signal data with a plurality of respective elements of the predicted filter matrix and to sum the results of the convolving of the representation of the audio signal data with the plurality of respective elements of the predicted filter matrix to generate the predicted spatial audio signal. In an example embodiment, the instructions, when executed by the apparatus, further cause the apparatus to generate a simulated audio signal data for respective ones of a plurality of combinations of audio scenes and microphone arrays and to generate a simulated reference audio signal for respective ones of the plurality of combinations of audio scenes and microphone arrays. The instructions, when executed by the apparatus, cause the apparatus of this example embodiment to repeatedly provide geometry data and audio signal data to the microphone geometry assisted encoder model, generate the predicted filter matrix, convolve the representation of the audio signal data with the predicted filter matrix, perform the comparison and train the microphone geometry assisted encoder model by using different simulated audio signal data and different simulated reference audio signals for the audio signal data and the reference audio signal, respectively.

The microphone geometry assisted encoder model may include a U-net model. The geometry data of an example embodiment may include a number of microphones and a location of respective microphones of the plurality of microphones. In an example embodiment, the instructions, when executed by the apparatus, further cause the apparatus to convert the audio signal data from a time domain to a frequency domain prior to provision of the audio signal data to the microphone geometry assisted encoder model and prior to convolution with the predicted filter matrix. The instructions, when executed by the apparatus, further cause the apparatus of an example embodiment to increase dimensionality of the geometry data prior to provision to the geometry encoder.

In yet another embodiment, an apparatus is provided that includes means for providing geometry data related to a plurality of microphones of a microphone array and audio signal data to a microphone geometry assisted encoder model. The microphone geometry assisted encoder model includes a geometry encoder configured to encode the geometry data and a signal encoder configured to encode the audio signal data. The geometry encoder and the signal encoder respectively include a plurality of layers and the microphone geometry assisted encoder model also includes a plurality of connection links configured to connect respective layers of the geometry encoder and the signal encoder such that the signal encoder is configured to process both geometric data and audio signal data. The microphone geometry assisted encoder model further includes a signal decoder having a plurality of layers and configured to generate an output, a plurality of connection links configured to connect respective layers of the signal encoder and the signal decoder, and a bottleneck connector between the signal encoder and the signal decoder. The apparatus also includes means for generating a predicted spatial audio signal based on the output of the microphone geometry assisted encoder model and means for performing a comparison of the predicted spatial audio signal with a representation of a reference audio signal. The apparatus further includes means for training the microphone geometry assisted encoder model by modifying the microphone geometry assisted encoder model based upon the comparison.

The means for generating the predicted spatial audio signal may include means for generating a predicted filter matrix with the microphone geometry assisted encoder model and means for convolving a representation of the audio signal data with the predicted filter matrix to generate the predicted spatial audio signal. In this embodiment, the means for convolving the representation of the audio signal data with the predicted filter matrix may include means for convolving the representation of the audio signal data with a plurality of respective elements of the predicted filter matrix and means for summing results of the convolving of the representation of the audio signal data with the plurality of respective elements of the predicted filter matrix to generate the predicted spatial audio signal. In an example embodiment, the apparatus further includes means for generating a simulated audio signal data for respective ones of a plurality of combinations of audio scenes and microphone arrays and means for generating a simulated reference audio signal for respective ones of the plurality of combinations of audio scenes and microphone arrays. The apparatus of this example embodiment may be configured to repeatedly provide geometry data and audio signal data to the microphone geometry assisted encoder model, generate the predicted filter matrix, convolve the representation of the audio signal data with the predicted filter matrix, perform the comparison and train the microphone geometry assisted encoder model by using different simulated audio signal data and different simulated reference audio signals for the audio signal data and the reference audio signal, respectively.

The microphone geometry assisted encoder model may include a U-net model. The geometry data of an example embodiment may include a number of microphones and a location of respective microphones of the plurality of microphones. In an example embodiment, the apparatus also includes means for converting the audio signal data from a time domain to a frequency domain prior to provision of the audio signal data to the microphone geometry assisted encoder model and prior to convolution with the predicted filter matrix. The apparatus of an example embodiment further includes means for increasing dimensionality of the geometry data prior to provision to the geometry encoder.

### BRIEF DESCRIPTION OF THE FIGURES

Having thus described some example embodiments of the present disclosure in general terms, reference will hereinafter be made to the accompanying drawings, which are not necessarily drawn to scale, and wherein:

FIG. 1 is a block diagram of an apparatus configured to generate spatial audio signals using a trained microphone geometry assisted encoder model that is configured to process audio signal data captured by a plurality of microphones of an audio capturing device in accordance with an example embodiment;

FIG. 2 is a representation of a microphone geometry assisted encoder model in accordance with an example embodiment;

FIG. 3 is a representation of one layer of a geometry encoder and a corresponding layer a signal encoder of the microphone geometry assisted encoder model of FIG. 2;

FIG. 4 is a block diagram of an apparatus that may be configured to implement the trained microphone geometry assisted encoder model and the associated signal processing of FIG. 1;

FIG. 5 is a flowchart illustrating operations performed in order to generate a spatial audio signal using a trained microphone geometry assisted encoder model as shown in FIG. 1 and in accordance with an example embodiment;

FIG. 6 is a block diagram of an apparatus configured to train a microphone geometry assisted encoder model in accordance with an example embodiment;

FIG. 7 is a block diagram illustrating the generation of simulated audio signal data for use in relation to training the microphone geometry assisted encoder model of FIG. 6 in accordance with an example embodiment; and

FIG. 8 is a flowchart illustrating the operations performed in order to train the microphone geometry assisted encoder model of FIG. 6 in accordance with an example embodiment.

### DETAILED DESCRIPTION

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that use software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

Spatial audio signals can be captured by an audio capturing device that includes a plurality of microphones, such as a microphone array. The microphones of the microphone array may be arranged in various positions relative to one another and may be configured to capture the same spatial audio signals. By capturing spatial audio signals with a plurality of microphones, level and time differences may be perceived between pairs of the microphones. These level and time differences can be utilized to extract spatial information from the signals including information regarding the direction of arrival of audio signals from different sound sources which, in turn, can be utilized to describe the spatial audio scene. Using this information during reproduction of the spatial audio signals results in the recreation of the same or similar sound field to that captured by the plurality of microphones.

Spatial audio encoding may be considered as a least-squares matching problem. The input signals to the spatial audio encoding process are the directional responses of the microphone array and the targeted encoding of the input signals generate the corresponding Ambisonics signals. The Ambisonics signals are based on spherical harmonics which may be simplified in an instance of spherical microphone arrays. A similar least-square solution can be adopted for irregular arrays, resulting in an encoding matrix of filters.

Irregular microphone array geometries, that is, microphone arrays that include a plurality of microphones that are not evenly and uniformly positioned, may be deployed in various applications, such as in conjunction with wearable microphone arrays for extensible reality applications. Irregular microphone array geometries create challenges for spatial audio encoding. In some instances, the encoding of spatial audio signals captured by irregular microphone array geometries may be constrained to a two-dimensional sound field, in contrast to a more generalized three-dimensional sound field. By constraining the sound field to two-dimensions, the encoding process may be improved at the expense of reduced elevation rendering. Other approaches utilize a signal-dependent encoder and assume a primary-ambiance directional model in an effort to reduce the limitations of signal-independent encoding. However, the performance of such encoding techniques relies on the accurate estimation of model parameters.

Machine learning solutions have also been proposed for Ambisonics encoding, including a solution using a convolutional neural network that is designed to improve encoding performance for higher-order spherical microphone arrays, particularly above the spatial aliasing frequency limit of the spherical microphone array in the region in which conventional encoding deteriorates. A tunable binaural audio telepresence system has also been proposed that introduces an input feature based on correlations between microphone pairs.

However, the techniques for spatial audio encoding typically fail to generalize to a plurality of different types of microphone arrays. For example, audio encoding techniques that rely upon digital signal processing generally have analysis and/or synthesis parameters related to the geometry of a microphone array that must be adjusted to perform properly when the audio signals are captured by a microphone array having a different geometry. This adjustment may require measurement of array characteristics, such as frequency sweep recordings of audio signals originating from predefined directions, to determine frequency-specific time and level differences between pairs of microphones of the microphone array. Some of the analysis and/or synthesis parameters may also require manual tuning based on trial and error. As such, significant effort may be required in order to modify a spatial audio capture technique that relies upon digital signal processing that has been developed with respect to a particular microphone array in order to realistically capture spatial audio signals by a microphone array having a different geometry.

For machine learning-based techniques of spatial audio capture, a model implementing a spatial capture algorithm must generally be tuned for a particular microphone array. This tuning process typically requires recording or simulating training data for the particular microphone array and then training the model accordingly. If the machine learning-based spatial audio capture technique is to be utilized with a microphone array having a different geometry, the model must generally be re-tuned in a manner that requires appreciable time and effort. As such, existing spatial audio capture techniques cannot readily be utilized in conjunction with audio capturing devices having microphone arrays with different geometries or microphone arrays for which geometry data is unknown, at least not without substantial time and effort in order to adapt the spatial audio capture technique to the different microphone array.

A method, apparatus and computer program product are provided in order to train and then utilize a microphone geometry assisted encoder model in order to generate spatial audio signals based upon audio signal data captured by a plurality of microphones of an audio capturing device. As described herein, the method, apparatus and computer program product are configured to be readily adaptable so as to generate spatial audio signals using the microphone geometry assisted encoder model for audio signal data captured by audio capturing devices having different types of microphone arrays with different geometries with little, if any, retraining of the model. Additionally, the method, apparatus and computer program product of an example embodiment are configured to generate spatial audio signals that represent audio signal data captured by different audio capturing devices having different microphone arrays with only limited information available regarding the geometry of the microphone arrays, such as information regarding the number of microphones and the location of respective microphones of the microphone array that is provided, for example, by the manufacturer of the audio capturing device.

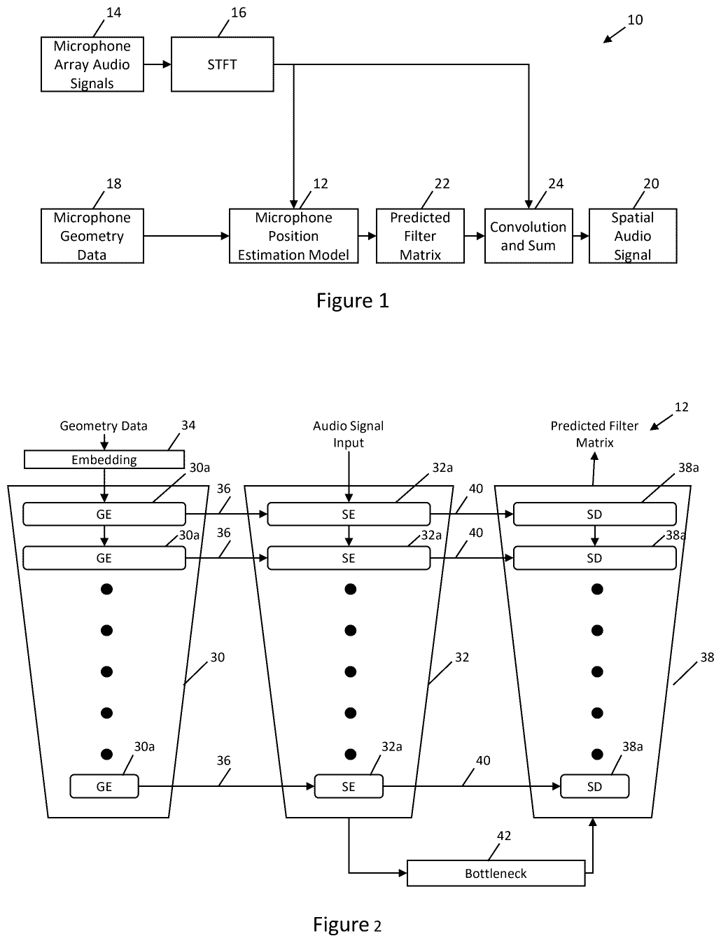

As shown in FIG. 1, an apparatus 10 is provided for generating spatial audio signals that represent audio signal data captured by a plurality of microphones of an audio capturing device. The audio signal data may be captured by any of a variety of audio capturing devices that utilize a microphone array or otherwise utilize a plurality of microphones including, for example, user equipment such as a mobile telephone or other mobile communications device, a personal computer or the like, a television or other display device, teleconferencing or telepresence systems or the like, a still or video camera or the like, a smart speaker device or the like, an augmented reality (AR), virtual reality (VR), immersive reality, extensible reality devices or the like, a vehicle (such as vehicle interior and/or exterior) or the like, or any combination thereof.

The apparatus 10 includes a trained microphone geometry assisted encoder model 12 that receives audio signal data 14, such as microphone array audio signals, captured by the plurality of microphones of the audio capturing device. Audio signal data 14 may be provided for each of a plurality of sound sources in an audio scene. In the illustrated embodiment, the audio signal data 14 may be converted from the time domain in which the audio signal data is captured to the frequency domain for processing utilizing, for example, a fast Fourier transform (FFT), such as a short-time Fourier transform (STFT) 16. The trained microphone geometry assisted encoder model 12 also receives geometry data 18 related to the plurality of microphones of the audio capturing device. For example, the trained microphone geometry assisted encoder model 12 may receive metadata, such as the metadata provided by the manufacturer of the audio capturing device, related to the microphones of the audio capturing device. However, the geometry data 18 received by the microphone geometry assisted encoder model 12 may be limited, such as to the number of microphones and the location of the microphones of the audio capturing device, and need not include more detailed geometry data 18.

In some embodiments, however, the geometry data 18 also includes information regarding directional magnitude and phase responses of the audio signals captured by the plurality of microphones of the audio capturing device. In this regard, some audio capturing devices have a solid body that creates complex scattering as the sound travels thereabout. In these scenarios, the geometry data 18 may also include information regarding the directional magnitude and phase responses of audio signals captured by the plurality of microphones. The directional magnitude and phase responses of the audio signals may be directly measured and provided to the microphone geometry assisted encoder model 12. Alternatively, information from which the effect of the body of the audio capturing device upon the directional magnitude and phase responses of the audio signals can be estimated may be provided, such as in the form of a computer-aided design model or a geometry mesh representing the audio capturing device, or at least that portion of the audio capturing device that houses the microphone array.

The microphone geometry assisted encoder model 12 is configured to generate output upon which a spatial audio signal 20 is based. For example, the microphone geometry assisted encoder model 12 may be trained so as to output the spatial audio signal 20 itself, such as an Ambisonics signal. In the illustrated embodiment, however, the microphone geometry assisted encoder model 12 is trained to generate a predicted filter matrix 22, such as a complex-valued filter matrix, configured to transform input microphone array audio signal data 14 to spatial audio signals 20 that appear to have been captured at the center of the microphone array. For a microphone array of N microphones and spatial audio signals 20, e.g., Ambisonics signals, having M output channels, the filter matrix has a shape and size of M×N. In this example embodiment, a representation of the audio signal data 14, such as a frequency-based representation of the audio signal data 14, may then be convolved, e.g., multiplied in the frequency domain, with the predicted filter matrix 22 and the result of the convolution may be summed to generate the spatial audio signal 20, such as an Ambisonics signal, see block 24 of FIG. 1. The predicted filter matrix 22 may include a plurality of elements, e.g., M×N elements, with the representation of the audio signal data 14 then being convolved with the plurality of respective elements of the predicted filter matrix 22. For example, each input channel of the audio signal data 14 may be convolved, e.g., multiplied in the frequency domain, with a separate filter in the predicted filter matrix 22, namely, the elements of the predicted filter matrix 22 associated with the respective input channel, and the convolved outputs are summed to produce a single output channel representing the spatial audio signal 20.

The microphone geometry assisted encoder model 12 may be any of a variety of models including, for example, a U-net model. As depicted in FIG. 2, the microphone geometry assisted encoder model 12 may include a geometry encoder 30 configured to encode the geometry data 18 and a signal encoder 32 configured to encode the audio signal data 14, such as a representation of the audio signal data 14 in the frequency domain. In an example embodiment, the geometry data 18 may be processed, such as by an embedding function 34, so as to increase the dimensionality of the geometry data 18 prior to its provision to the geometry encoder 30. For example, geometry data 18 in the form of the number of microphones and the location, such as the x, y and z locations (with the center of the microphone array serving as the origin of the coordinate system), of the microphones of a microphone array may have lower dimensionality than the audio signal data 14 that is provided in the frequency domain for each of a plurality of separate sound sources in an audio scene. The dimensionality of the geometry data 18 may therefore be increased to match or at least more closely approximate the dimensionality of the audio signal data 14 prior to provision to the geometry encoder 30. For example, the dimensionality of the geometry data 18 may be increased by adjusting the number of feature channels of geometry data to match, e.g., equal, the number of channels of the audio signal data 14.

The geometry encoder 30 and the signal encoder 32 may be separate encoders, but the geometry encoder 30 may be configured to provide information regarding geometry data 18 to the signal encoder 32. Each of the geometry encoder 30 and the signal encoder 32 includes a plurality of sequential layers 30a, 32a and, in some embodiments, the geometry encoder 30 and the signal encoder 32 include the same number of layers. As such, the geometry encoder 30 and the signal encoder 32 are multi-stage encoders. In an embodiment in which the microphone geometry assisted encoder model 12 is a U-net model, the layers 30a, 32a of each of the geometry encoder 30 and the signal encoder 32 are configured to progressively further encode the geometry data 18 and the audio signal data 14, respectively.

As also shown in FIG. 2, the microphone geometry assisted encoder model 12 includes a plurality of connection links 36 configured to connect respective layers 30a, 32a of the geometry encoder 30 and the signal encoder 32 such that the geometry encoder 30 provides a representation of the geometry data 18 to the signal encoder 32. As such, the geometry encoder 30 is configured to process only the geometry data 18, while the signal encoder 32 is configured to process both a representation of the geometry data 18 provided by the geometry encoder 30 and the audio signal data 14. The connection links 36 are defined such that a first connection link connects a first layer of the geometry encoder 30 and a first layer of the signal encoder 32. A second connection link connects a second layer of the geometry encoder 30 and a second layer of the signal encoder 32, and so forth until an n-th connection link connects an n-th layer of the geometry encoder 30 with an n-th layer of the signal encoder 32.

The microphone geometry assisted encoder model 12 also includes a signal decoder 38 configured to generate the output upon which the spatial audio signal 20 is based. In the illustrated embodiment, the signal decoder 38 is configured to generate the predicted filter matrix 22 with which a representation of the audio signal data 14 is then convolved to generate the spatial audio signal 20. The signal decoder 38 also includes a plurality of layers 38a and, in one embodiment, includes the same number of layers as the geometry encoder 30 and signal encoder 32. The microphone geometry assisted encoder model 12 also includes a plurality of connection links 40 configured to connect respective layers 32a, 38a of the signal encoder 32 and the signal decoder 38. For example, a first connection link may connect a first layer of the signal encoder 32 and a first layer of the signal decoder 38. A second connection link connects a second layer of the signal encoder 32 and a second layer of the signal decoder 38, and so forth until an n-th connection link connects an n-th layer of the signal encoder 32 with an n-th layer of the signal decoder 38. The microphone geometry assisted encoder model 12 also includes a bottleneck connector 42 between the signal encoder 32 and the signal decoder 38, between the lowest layer of the signal encoder 32 and the lowest layer of the signal decoder 38.

In an embodiment in which the microphone geometry assisted encoder model 12 is a U-net model, the geometry encoder 30 and the signal encoder 32 process the geometry data 18 and the audio signal data 14, respectively, downward through the layers 30a, 32a depicted in FIG. 2 in order to progressively further encode the geometry data 18 and the audio signal data 14. Conversely, the signal decoder 38 processes the signals upwardly through the layers 38a so as to progressively decode the signals and generate the output upon which the spatial audio signal 20 is based, such as by generating a predicted filter matrix 22.

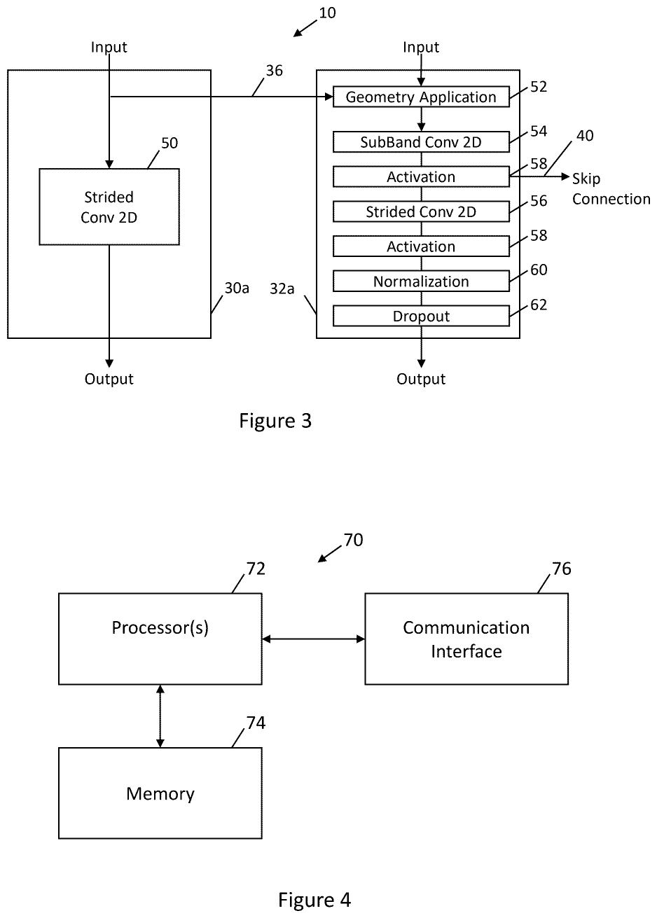

Although the layers 30a, 32a of the geometry encoder 30 and the signal encoder 32 may be configured in various manners, FIG. 3 depicts an example embodiment of a corresponding layers 30a, 32a of the geometry encoder 30 and the signal encoder 32. Although a single layer 30a, 32a of the geometry encoder 30 and signal encoder 32 is depicted, each layer 30a, 32a of the geometry encoder 30 and the signal encoder 32 may be configured in the same manner. As shown, the layer 30a of the geometry encoder 30 may include a strided two-dimensional convolution operation 50 in order to down sample the geometry data 18, such as may be provided by a higher layer of the geometry encoder 30, prior to provision to a lower layer of the geometry encoder 30. In this regard, the strided two dimensional convolution operation is configured to decrease the size of the data, e.g., geometry data 18, in both time and frequency dimensions. As also shown, the corresponding layer of the signal encoder 32 includes at least two convolution operations, such as a sub-band two-dimensional convolution operation 54 and a strided two-dimensional convolution operation 56. Each convolution operation is followed by an activation function, such as a non-linear activation function 58. The layer 32a of the signal encoder 32 may also comprise a normalization function 60, such as a batch or layer normalization function, and a dropout function 62 configured to avoid overfitting during training by generating a signal that is output from the respective layer 32a for provision to the next lower layer of the signal encoder 32. As shown in FIG. 3, the layer 32a of the signal encoder 32 also receives geometry data 18 from the corresponding layer 30a of the geometry encoder 30. As such, the layer 32a of the signal encoder 32 may also include a geometry application operation 52 for applying the geometry data 18 to the audio signal data 14 provided by the immediately prior layer of the signal encoder 32.

Although a layer 30a of the geometry encoder 30 and a layer 32a of the signal encoder 32 are illustrated and described above, these layers are provided by way of example and not as limitation and the layers 30a, 32a of the geometry encoder 30 and the signal encoder 32 may be configured in other manners in other embodiments. For example, instead of a strided two-dimensional convolution operation, a two-dimensional convolution operation that is not strided may be employed followed by a downsampling operation. Alternatively, the strided two-dimensional convolution operation may be replaced by a MaxPool2D operation or by an interpolation technique in order to decrease the size of the data.

The layers 38a of the signal decoder 38 are configured in the same manner as the layers 32a of the signal encoder 32 (albeit with the geometry application operation 52), although processing provided by the layers 38a of the signal decoder 38 progresses in the opposite direction, such as from a lower layer to an upper layer, from that of the signal encoder 32. By way of example but not of limitation, each layer 38a of the signal decoder 38 may include an upsampling operation, such as a TransposeConv2D operation, with the results being concatenated in the channel dimension with the data received via the connection link 40 for the respective layer 38a. The layer 38a of the signal decoder 38 may also include at least two convolution operations, such as the same convolution operations described above with respect to a layer 32a of the signal encoder 32. Each convolution operation of a layer 38a of the signal decoder 38 is also followed by a respective non-linear activation function. Each layer 38a of the signal decoder 38 of one embodiment also includes a normalization function and a dropout function to provide the signals to the next higher layer of the signal decoder 38. As such, the signal decoder 38 is configured to decode the signals in the same manner in which the signals were previously encoded.

In an example embodiment, the microphone geometry assisted encoder model 12 is configured to receive complex-valued inputs, such as complex-valued representations of the audio signal data 14. The real and imaginary components of the complex-valued inputs are separated into separate real values and then processed as separate feature channels within the microphone geometry assisted encoder model 12. At the output of the microphone geometry assisted encoder model 12 of this example embodiment, pairs of feature channels (representing the real and imaginary components of the same complex-valued representation of audio signal data 14) are combined to form a complex-valued feature channel with one feature channel of the pair serving as the real component and the other feature channel of the pair serving as the imaginary component of the complex-valued feature channel.

The apparatus 10 for generating a spatial audio signal including the microphone geometry assisted encoder model 12 as shown in FIG. 1 may be embodied by any of a variety of computing devices. One example of an apparatus 70 that includes the microphone geometry assisted encoder model 12 and the associated processing functions of FIG. 1 in order to generate a spatial audio signal 20 is shown in FIG. 4. The apparatus 70 of FIG. 4 may be embodied by a server, user equipment, such as a mobile terminal or other mobile communications device, a personal computer or the like, a television or other display device, teleconferencing or telepresence systems or the like, a still or video camera or the like, a smart speaker device or the like, an augmented reality (AR), virtual reality (VR), immersive reality, extensible reality devices or the like, a vehicle (such as vehicle interior and/or exterior) or the like, or any combination thereof, or other type of computing device. The apparatus 70 may include, be associated with, or be in communication with at least one processor 72, a memory 74 and a communication interface 76. The at least one processor 72 may be in communication with the memory 74 (also referred to as a memory device) via a bus for passing information among components of the apparatus 70. The memory device 74 may be non-transitory and may include, for example, one or more volatile and/or non-volatile memories. In other words, for example, the memory device 74 may be an electronic storage device (e.g., a computer readable storage medium) comprising gates configured to store data (e.g., bits) that may be retrievable by a machine (e.g., a computing device including the at least one processor 72). The memory device 74 may be configured to store information, data, content, applications, instructions, or the like for enabling the apparatus 70 to carry out various functions in accordance with an example embodiment of the present disclosure. For example, the memory device 74 could be configured to buffer input data for processing by the at least one processor 72. Additionally, or alternatively, the memory device 74 could be configured to store instructions for execution by the at least one processor 72.

The apparatus 70 may, in some embodiments, be embodied in various computing devices as described above. However, in some embodiments, the apparatus 70 may be embodied as a chip or chip set. In other words, the apparatus 70 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 70 may therefore, in some cases, be configured to implement an embodiment of the present disclosure on a single chip or as a single “system on a chip.” As such, in some cases, a chip or chipset may constitute means for performing one or more operations for providing the functionalities described herein.

The at least one processor 72 may be embodied in a number of different ways. For example, the at least one processor 72 may be embodied as one or more of various hardware processing means such as processing circuitry including a coprocessor, a microprocessor, a controller, a digital signal processor (DSP), a central processing unit (CPU), a graphics processing unit (GPU), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the at least one processor 72 may include one or more processing cores configured to perform independently. A multi-core processor may enable multiprocessing within a single physical package. Additionally, or alternatively, the at least one processor 72 may include one or more processors configured in tandem via the bus to enable independent execution of instructions, pipelining and/or multithreading. In an example embodiment, the at least one processor 72 may be configured to execute instructions stored in the memory device 74 or otherwise accessible to the at least one processor 72. Alternatively, or additionally, the at least one processor 72 may be configured to execute hard coded functionality. As such, whether configured by hardware or software methods, or by a combination thereof, the at least one processor 72 may represent an entity (e.g., physically embodied in processing circuitry) capable of performing operations according to an embodiment of the present disclosure while configured accordingly. Thus, for example, when the at least one processor 72 is embodied as an ASIC, FPGA or the like, the at least one processor 72 may be specifically configured hardware for conducting the operations described herein. Alternatively, as another example, when the at least one processor 72 is embodied as an executor of instructions, the instructions may specifically configure the at least one processor 72 to perform the algorithms and/or operations described herein when the instructions are executed. However, in some cases, the at least one processor 72 may be a processor of a specific device (e.g., an image or video processing system) configured to employ an embodiment of the present disclosure by further configuration of the at least one processor 72 by instructions for performing the algorithms and/or operations described herein. The at least one processor 72 may include, among other things, a clock, an arithmetic logic unit (ALU) and logic gates configured to support operation of the at least one processor 72.

The communication interface 76 may be any means such as a device or circuitry embodied in either hardware or a combination of hardware and software that is configured to receive and/or transmit data over wired and/or wireless communication networks, including media content in the form of video or image files, a video or image stream or other type of transmission, one or more audio tracks, streams or other type of transmission, or the like. In this regard, the communication interface 76 may include, for example, an antenna (or multiple antennas) and supporting hardware and/or software for enabling communications with a wireless communication network, for example, a short range wireless communication network, such as wireless local area network (WLAN), Bluetooth® network, or wireless telecommunication network, such as 4G/5G/6G of 3GPP (4^{th}/5^{th}/6^{th} generation, or any further generations of the 3rd Generation Partnership Project). The communication interface 76 may also include a plurality of microphones, such as a microphone array, for receiving audio signals to then be provided, for example, to the at least one processor 72. Additionally, or alternatively, the communication interface 76 may include the circuitry for interacting with the antenna(s) to cause transmission of signals via the antenna(s) or to handle receipt of signals received via the antenna(s). In some environments, the communication interface 76 may alternatively or also support wired communication. As such, for example, the communication interface 76 may include a communication modem and/or other hardware/software for supporting communication via cable, digital subscriber line (DSL), universal serial bus (USB) or other mechanisms.

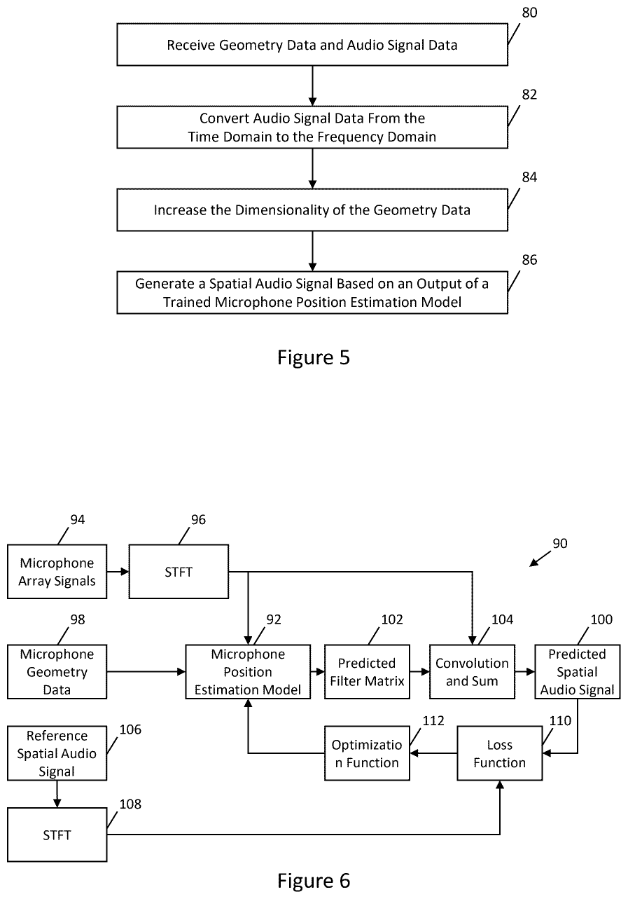

As described above, the microphone geometry assisted encoder model 12 generates the output upon which the spatial audio signal 20 is based. For example, the microphone geometry assisted encoder model 12 may generate a predicted filter matrix 22 with which a representation of the audio signal data 14, such as a frequency representation of the audio signal data 14, may be convolved with the results of the convolution then being summed to generate the resulting spatial audio signal 20, such as an Ambisonics signal. In this regard, FIG. 5 is a flow chart illustrating the operations performed in order to generate the spatial audio signal 20. With reference to the apparatus of FIG. 4 and as described above, the apparatus 70 includes means, such as the communication interface 76, the at least one processor 72 or the like, for receiving geometry data 18 related to the plurality of microphones of an audio capturing device and audio signal data 14 captured by the plurality of microphones, see block 80 of FIG. 5. The apparatus 70 also includes means, such as the at least one processor 72 or the like, for generating the spatial audio signal 20 based on an output of a trained microphone geometry assisted encoder model 12, see block 86.

In an example embodiment, the apparatus 70 is configured to generate the spatial audio signal 20 based on the output of a trained microphone geometry assisted encoder model 12 by including means, such as the at least one processor 72 or the like, for generating a predicted filter matrix 22 with the trained microphone geometry assisted encoder model 12. In this embodiment, the apparatus 70 also includes means, such as the at least one processor 72 or the like, for convolving a representation of the audio signal data 14 with the predicted filter matrix 22 to generate the spatial audio signal 20. For example, the apparatus 70, such as the at least one processor 72, may be configured to convolve the representation of the audio signal data 14 with the predicted filter matrix 22 by including means, such as the at least one processor 72 or the like, for convolving the representation of the audio signal data 14 with a plurality of respective elements of the predicted filter matrix 22 and then summing the results of the convolving of the representation of the audio signal data 14 with the plurality of respective elements of the predicted filter matrix 22 to generate the spatial audio signal 20.

As shown in block 82 of FIG. 5, the apparatus 70 of an example embodiment also includes means, such as the at least one processor 72, the STFT 16 or the like, for converting the audio signal data 20 from the time domain to the frequency domain prior to provision of the audio signal data 20 to the trained microphone geometry assisted encoder model 12 and prior to convolution with the predicted filter matrix 22. As also shown in block 84 of FIG. 5, the apparatus 70 of an example embodiment may include means, such as the at least one processor 72 or the like, for increasing the dimensionality of the geometry data 18 prior to provision of the geometry data 18 to the geometry encoder 30 of the trained microphone geometry assisted encoder model 12.

By utilizing the trained microphone geometry assisted encoder model 12, spatial audio signals 20 may be generated in order to accurately represent an audio scene. The microphone geometry assisted encoder model 12 allows the spatial audio signals 20 to be generated for audio signal data 14 captured by different microphone arrays with little, if any, retraining of the microphone geometry assisted encoder model 12. In this regard, the microphone geometry assisted encoder model 12 is configured to generate spatial audio signals 20 in response to only limited geometry data 18 relating to the microphone array being provided thereto. For example, the geometry data 18 as provided in accordance with an example embodiment includes only the number of microphones and the location of each of the microphones and not more detailed or nuanced information regarding the geometry data 18 associated with the microphones. Thus, the trained microphone geometry assisted encoder model 12 may efficiently generate spatial audio signals 20 for audio signal data 14 captured by a variety of different audio capturing devices having microphone arrays with different geometry and about which little information is known in advance other than the number of microphones and the location of each of the microphones. As such, the microphone geometry assisted encoder model 12 may readily adapt to generate spatial audio signals 20 for audio signal data 14 captured by a variety of different audio capturing devices with little, if any, retraining of the microphone geometry assisted encoder model 12, thereby making the introduction of audio capturing devices having different microphone array geometries a much more efficient process.

A method, apparatus and computer program product are also provided in accordance with an example embodiment in order to train a microphone geometry assisted encoder model. By way of example, FIG. 6 depicts an apparatus 90 configured to train a microphone geometry assisted encoder model 92 of the type described above, such as in relation to FIGS. 2-4. As described above, microphone geometry data 98 related to a plurality of microphones of the microphone array is provided to the microphone geometry assisted encoder model 92. The geometry data 98 may be limited to the number of microphones and the location of respective microphones of the plurality of microphones. In some embodiments, however, the geometry data 98 also includes information regarding the directional magnitude and phase responses of audio signals captured by the plurality of microphones. The audio signal data 94 is also provided to the microphone geometry assisted encoder model 92. The audio signal data 94 has been captured by the plurality of microphones of the audio capturing device and, in one embodiment, is converted from the time domain in which the audio signals are captured to the frequency domain, such as by an STFT 96, prior to provision to the microphone geometry assisted encoder model 92.

As described above, the microphone geometry assisted encoder model 92 includes a geometry encoder 30 configured to encode the geometry data 98 and a signal encoder 32 configured to encode the audio signal data 94. The geometry encoder 30 and the signal encoder 32 respectively comprise a plurality of layers 30a, 32a and the microphone geometry assisted encoder model 92 also includes a plurality of connection links 36 configured to connect the respective layers 30a, 32a of the geometry encoder 30 and the signal encoder 32 as depicted in FIG. 2. As such, the signal encoder 32 is configured to process both geometry data 98 and audio signal data 94. The microphone geometry assisted encoder model 92 also includes the signal decoder 38 including a plurality of layers 38a, and configured to generate an output upon which the predicted spatial audio signals 100 are based. The microphone geometry assisted encoder model 92 also includes a plurality of connection links 40 configured to connect respective layers 32a, 38a of the signal encoder 32 and the signal decoder 38, and a bottleneck connector 42 between the lowest layers of the signal encoder 32 and the signal decoder 38. The geometry encoder 30, the signal encoder 32 and the signal decoder 38 may be configured in various manners including as described above, such as with respect to FIG. 3 relative to the geometry encoder 30 and the signal encoder 32.

In the illustrated embodiment, the microphone geometry assisted encoder model 92 and the signal decoder 38 are configured to generate an output in the form of a predicted filter matrix 102. As described above, the predicted filter matrix 102 may include a plurality of respective elements. In this example embodiment, a representation of the audio signal data 94, such as a frequency representation of the audio signal data 94, may be convolved with the predicted filter matrix 102 to generate a predicted spatial audio signal 100, such as a predicted Ambisonics signal. For example, the frequency representation of the audio signal data 94 may be convolved with a plurality of respective elements of the predicted filter matrix 102, and the results of the convolving of the representation of the audio signal data 94 with the plurality of respective elements of the predicted filter matrix 102 may be summed to generate the predicted spatial audio signal 100, see block 104 of FIG. 6.

In order to train the microphone geometry assisted encoder model 92, a reference spatial audio signal 106 is also provided. The reference spatial audio signal 106 represents the spatial audio signal 100 that is expected to be received at the center of the plurality of microphones, that is, at the center of the microphone array, and that therefore represents the output that the microphone geometry assisted encoder model 92 is being trained to predict. In the illustrated embodiment, the reference spatial audio signal 106 may be converted from the time domain in which the audio signals are received to the frequency domain, such as by an STFT 108. The representation of the reference spatial audio signal 106 is then compared to the predicted spatial audio signal 100, such as by a loss function 110, to determine the difference therebetween. The resulting difference between the representation of the reference spatial audio signal 106 and the predicted spatial audio signal 100 may then be utilized, such as by an optimization function 112, to modify the microphone geometry assisted encoder model 92, such as by modifying the weights of the respective layers 30a, 32a, 38a of the geometry encoder 30, signal encoder 32 and/or signal decoder 38 in order to more accurately predict the spatial audio signal 100. For example with respect to the embodiment of the layers 30a, 32a, 38a depicted in FIG. 3 and described above, the weights associated with the Conv2D, normalization, dropout, and TransposeConv2D operations may be modified, but the activation, concatenation and multiplication operations are not learnable and therefore are not associated with weights to be modified By repeating this process with different microphone arrays and different audio data signals 94, such as representative of different sound scenes, the microphone geometry assisted encoder model 92 is trained to accurately generate spatial audio signals 100 for a variety of different sound scenes and for a variety of different microphone arrays having differently positioned microphones with only limited geometry data 98 available to the microphone geometry assisted encoder model 92, such as by only providing the number of microphones and the position of each of the microphones of the microphone array to the microphone geometry assisted encoder model 92.

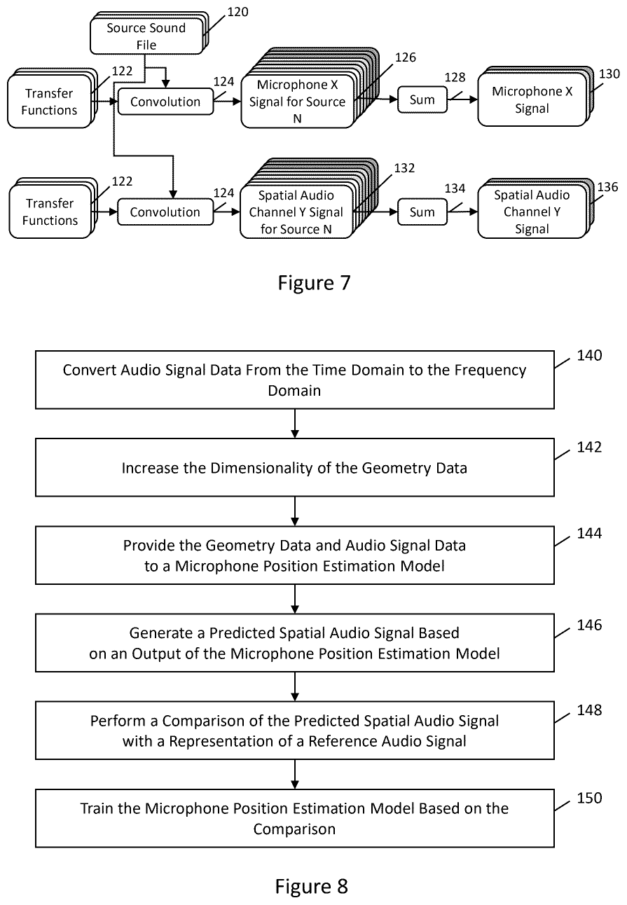

In order to train the microphone geometry assisted encoder model, substantial audio signal data 94 and geometry data 98 are advantageously provided to the microphone geometry assisted encoder model 92. In an example embodiment, the audio signal data 94 and the geometry data 98 are simulated, thereby allowing the microphone geometry assisted encoder model 92 to be efficiently and thoroughly trained, resulting in more accurate prediction of the spatial audio signals 100. In this example embodiment depicted in FIG. 7, simulated audio signal data is generated for respective ones of a plurality of combinations of audio scenes and microphone arrays. Similarly, simulated reference audio signals are generated for respective ones of the plurality of combinations of audio scenes and microphone arrays.

In order to generate the simulated audio signal data and the simulated reference audio signals, a plurality of source sound files 120 may be provided for a plurality of sound sources of a sound scene. Additionally, transfer functions 122 from each sound source of a sound scene to each microphone of the plurality of microphones of an audio capturing device are determined. The transfer functions 122 are based, in part, on the sound scene including a room definition including a shape and dimensions of the room through which the audio signals propagate, as well as materials that form components of the room, such as wall coverings, furnishings and the like, which affect reverberation characteristics of the room. Input parameters to the transfer functions also include location of the sound sources and location at which the audio signals are captured, such as the location of the microphones. The transfer functions 122 are defined by the microphone distance from the sound source and the directional response of the respective microphone. In a free field model in which a microphone has ideal omni directivity and ideal frequency response, the distance will only affect the phase of the signal being received. The transfer functions 122 may be defined in various manners including, for example, using an image-source method for simulating the emanation of sound in the room. Other techniques include a finite element model (FEM) or a bound element model (BEM). The transfer function 122 may be provided in the time domain or frequency domain.

Once the transfer functions 122 have been defined, the audio signals from the sound source file 120 may be convolved with the transfer function 122, such as the impulse response, to generate a signal emanating from a particular sound source (designated source N in FIG. 7) that is captured by a respective microphone (designated microphone X in FIG. 7), see blocks 124 and 126 of FIG. 7. This process may be repeated for the same audio signal emanating from the same sound source for each of the different microphones of a microphone array. This process may then be repeated for each of a plurality of sound sources within the audio scene. The audio signals captured by each respective microphone for audio signals emanating from each of the different sound sources within the audio scene may then be summed to generate a composite audio signal for each microphone, see blocks 128 and 130 of FIG. 7.

Utilizing the same sound source files 120 for the plurality of sound sources in the sound scene, a reference audio signal may also be generated for each channel, such as channel Y in block 132 of FIG. 7. In order to generate the reference audio signal, transfer functions 122 are determined from each sound source of a sound scene to a reference position relative to the plurality of microphones of an audio capturing device, such as to the center of the plurality of microphones. Once the transfer functions 122 have been defined, the audio signals from the sound source file 120 may be convolved with the transfer function 122, such as the impulse response, to generate a signal emanating from a particular sound source (designated source N in FIG. 7) that would be received at the reference position, e.g., the center, of the plurality of microphones, see blocks 124 and 132 of FIG. 7.

The process of generating the reference audio signal may be repeated for each sound source within the audio scene and for each channel of the reference audio signal with the results summed for a respective channel for the plurality of sound sources to generate a respective reference audio signal for each of a plurality of channels, see blocks 134 and 136 of FIG. 7 and the reference audio signal generated for channel Y that is designated as spatial audio channel Y signal in FIG. 7. As each channel of the reference audio signal is based on audio signals that would be received at the same reference point, e.g., center, of the plurality of microphones, there is no phase differences due to the point at which the audio signals are to be received. However, each channel of the reference audio signal has a specific directional magnitude response defined by the spherical harmonics of the audio signals from the sound source file 120.

As such, the apparatus 90 may repeatedly provide geometry data 98 and audio signal data 94 to the microphone geometry assisted encoder model 92, generate the predicted filter matrix 102, convolve the representation of the audio signal data 94 with the predicted filter matrix 102 to generate predicted spatial audio signals 100, perform the comparison of the predicted spatial audio signals and the reference audio signals (see block 110) and train the microphone geometry assisted encoder model 92 using different simulated audio signal data 130 and different simulated reference audio signals 136 for the audio signal data 94 and the reference audio signals, respectively. In this regard, the process may be repeated for the sound sources of different sound scenes resulting in different sound source files 120 and for different microphone arrays having different configurations of microphones (generally selected from a controlled distribution of microphone array characteristics) resulting in different transfer responses. In an example embodiment, simulated audio signal data 130 and simulated reference audio signals 136 are generated based upon sound scenes have a variety of sound source directions, sound source audio types and different numbers of sound source combinations and also based upon different microphone arrays having different numbers of microphones and differently positioned microphones. In at least some embodiments, the total number of different microphone arrays that are utilized in the simulation process can be limited to ensure some redundancy in the microphone arrays that are utilized with the different sound scenes such that some of the signals are simulated for different sound scenes but with the same microphone array. Similarly, the simulation process may generate some of the simulated signals using the same sound scene but with different microphone arrays. By simulating the audio signal data 130 and the reference audio signals 132, the microphone geometry assisted encoder model 92 may be more thoroughly trained in a more efficient manner, thereby resulting in improved prediction of the spatial audio signals 100 by the trained machine geometry assisted encoder model 92.

The apparatus 90 for training the microphone geometry assisted encoder model 92 as shown in FIG. 6 may be embodied by any of a variety of computing devices. By way of example, the apparatus 70 of FIG. 4 may also be configured to train the microphone geometry assisted encoder model 92 in the manner depicted in FIG. 6. In this regard, the operations performed in order to train the microphone geometry assisted encoder model 92 are depicted by the flow chart of FIG. 8 in relation to the apparatus 70 of FIG. 4. In this regard, the apparatus 70 includes means, such as the at least one processor 72, the communication interface 76 or the like, for providing geometry data 98 related to a plurality of microphones of a microphone array and audio signal data 94 to the microphone geometry assisted encoder model 92, see block 144 of FIG. 8. The apparatus 70 includes means, such as the at least one processor 72 or the like, for generating a predicted spatial audio signal 100 based on the output of the microphone geometry assisted encoder model 92, see block 146. The apparatus 70 also includes means, such as the at least one processor 72 or the like, for performing a comparison of the predicted spatial audio signal 100 with a representation of a reference audio signal 106 and means, such as the at least one processor 72 of the like, for training the microphone geometry assisted encoder model 92 by modifying the microphone geometry assisted encoder model 92 based on the comparison, see blocks 148 and 150 of FIG. 8.

In an example embodiment in which the output of the microphone geometry assisted encoder model 92 is a predicted filter matrix 102, the apparatus 70 configured to generate the predicted spatial audio signal 100 includes means, such as the at least one processor 72 or the like, for generating the predicted filter matrix 102 with the microphone geometry assisted encoder model 92 and means, such as the at least one processor 72 or the like, for convolving a representation of the audio signal data 94 with the predicted filter matrix 102 to generate the predicted spatial audio signal 100. In this regard, the apparatus 70 may include means, such as the at least one processor 72 or the like, for convolving the representation of the audio signal data 94 with a plurality of respective elements of the predicted filter matrix 102 and means, such as the at least one processor 72 or the like, for summing results of the convolving of the representation of the audio signal data 94 with the plurality of respective elements of the predicted filter matrix 102 to generate the predicted spatial audio signal 100.

In an example embodiment, the process is repeated for a variety of different audio signal data 94 and reference audio signals 106. As such, in this example embodiment, the apparatus 70 may also include means, such as the at least one processor 72 or the like, for generating a simulated audio signal data 130 for respective ones of a plurality of combinations of audio scenes and microphone arrays. In addition, the apparatus 70 of this example embodiment may include means, such as the at least one processor 72 or the like, for generating a simulated reference audio signal 136 for respective ones of the plurality of combinations of audio scenes and microphone arrays. The process is then repeated using different simulated audio signal data 130 and different simulated reference audio signals 136. By simulating the audio signal data 130 and the reference audio signals 136, the microphone geometry assisted encoder model 92 may be thoroughly trained in an efficient manner, thereby resulting in improved prediction of the spatial audio signals 100 by the trained machine geometry assisted encoder model 92.

In an example embodiment, the apparatus 70 also includes means, such as the at least one processor 72 or the like, for converting the audio signal data 94 from a time domain to a frequency domain prior to provision of the audio signal data 94 to the microphone geometry assisted encoder model 92 and prior to convolution with the predicted filter matrix 102, see block 140 of FIG. 8. In an example embodiment, the apparatus 70 also includes means, such as the at least one processor 72 or the like, for increasing dimensionality of the geometry data 98 prior to provision to the microphone geometry assisted encoder model 92, such as the geometry encoder 30, such that the dimensionality of the geometry data 98 matches or more closely approximates the dimensionality of the audio signal data 94, see block 142 of FIG. 8.

Accordingly, the microphone geometry assisted encoder model 92 is trained in an efficient manner and is then utilized to generate spatial audio signals 20 from audio signal data 14 captured by different microphone arrays with little, if any, retraining of the microphone geometry assisted encoder model 12. Additionally, by training the microphone geometry assisted encoder model 92 in this manner, the trained microphone geometry assisted encoder model 12 is configured to generate spatial audio signals 20 in response to limited geometry data 18 relating to the microphone array being provided thereto. For example, the geometry data 18 as provided in accordance with an example embodiment includes the number of microphones and the location of each of the microphones and not more detailed information regarding the geometry data associated with the microphones. As such, the microphone geometry assisted encoder model 12 readily adapts to generate spatial audio signals 20 for audio signal data 14 captured by a variety of different audio capturing devices.

FIGS. 5 and 8 illustrate flowcharts depicting methods according to an example embodiment of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 74 of an apparatus 70 employing an embodiment of the present disclosure and executed by at least one processor 72. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks. Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the disclosure set forth herein will come to mind to one skilled in the art to which the disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe some example embodiments in the context of some example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense and not for purposes of limitation.

What is claimed is:

1. An apparatus comprising:
at least one processor; and
at least one memory storing instructions that, when executed by the at least one processor, cause the apparatus at least to perform:
receive geometry data related to a plurality of microphones of an audio capturing device and audio signal data captured by the plurality of microphones; and
generate a spatial audio signal based on an output of a trained microphone geometry assisted encoder model,
wherein the trained microphone geometry assisted encoder model comprises a geometry encoder configured to encode the geometry data and a signal encoder configured to encode the audio signal data,
wherein the geometry encoder and the signal encoder respectively comprise a plurality of layers and the trained microphone geometry assisted encoder model also comprises a plurality of connection links configured to connect respective layers of the geometry encoder and the signal encoder such that the signal encoder is configured to process both geometric data and audio signal data,
wherein the trained microphone geometry assisted encoder model further comprises a signal decoder comprising a plurality of layers and configured to generate the output upon which the spatial audio signal is based, a plurality of connection links configured to connect respective layers of the signal encoder and the signal decoder, and a bottleneck connector between the signal encoder and the signal decoder.

2. An apparatus according to claim 1, wherein the generation of the spatial audio signal based on the output of the trained microphone geometry assisted encoder model is further caused to generate a predicted filter matrix with the trained microphone geometry assisted encoder model and convolve a representation of the audio signal data with the predicted filter matrix to generate the spatial audio signal.

3. An apparatus according to claim 2, wherein the convolving of the representation of the audio signal data with the predicted filter matrix is further caused to convolve the representation of the audio signal data with a plurality of respective elements of the predicted filter matrix and to sum results of the convolving of the representation of the audio signal data with the plurality of respective elements of the predicted filter matrix to generate the spatial audio signal.

4. An apparatus according to claim 2, wherein the instructions, when executed by the at least one processor, further cause the apparatus to convert the audio signal data from a time domain to a frequency domain prior to provision of the audio signal data to the trained microphone geometry assisted encoder model and prior to convolution with the predicted filter matrix.

5. An apparatus according to claim 1, wherein the trained microphone geometry assisted encoder model comprises a U-net model.

6. An apparatus according to claim 1, wherein the geometry data comprises a number of microphones and a location of respective microphones of the plurality of microphones.

7. An apparatus according to claim 1, wherein a respective layer of the geometry encoder comprises a strided two dimensional (2D) convolution operation.

8. An apparatus according to claim 1, wherein a respective layer of the signal encoder comprises at least two convolution operations with a respective convolution operation followed by a non-linear activation function, wherein the respective layer of the signal encoder further comprises a dropout function to generate a signal output from the respective layer.

9. An apparatus according to claim 1, wherein a respective layer of the signal decoder comprises at least two convolution operations with a respective convolution operation followed by a non-linear activation function.

10. An apparatus according to claim 1, wherein the instructions, when executed by the at least one processor, further cause the apparatus to increase dimensionality of the geometry data prior to provision to the geometry encoder.

11. A method comprising:
receiving geometry data related to a plurality of microphones of an audio capturing device and audio signal data captured by the plurality of microphones; and
generating a spatial audio signal based on an output of a trained microphone geometry assisted encoder model,
wherein the trained microphone geometry assisted encoder model comprises a geometry encoder configured to encode the geometry data and a signal encoder configured to encode the audio signal data,
wherein the geometry encoder and the signal encoder respectively comprise a plurality of layers and the trained microphone geometry assisted encoder model also comprises a plurality of connection links configured to connect respective layers of the geometry encoder and the signal encoder such that the signal encoder is configured to process both geometric data and audio signal data,
wherein the trained microphone geometry assisted encoder model further comprises a signal decoder comprising a plurality of layers and configured to generate the output upon which the spatial audio signal is based, a plurality of connection links configured to connect respective layers of the signal encoder and the signal decoder, and a bottleneck connector between the signal encoder and the signal decoder.

12. A method according to claim 11, wherein generating the spatial audio signal based on the output of the trained microphone geometry assisted encoder model comprises generating a predicted filter matrix with the trained microphone geometry assisted encoder model and convolving a representation of the audio signal data with the predicted filter matrix to generate the spatial audio signal.

13. A method according to claim 12, wherein convolving the representation of the audio signal data with the predicted filter matrix comprises convolving the representation of the audio signal data with a plurality of respective elements of the predicted filter matrix and summing results of the convolving of the representation of the audio signal data with the plurality of respective elements of the predicted filter matrix to generate the spatial audio signal.

14. A method according to claim 12, further comprising converting the audio signal data from a time domain to a frequency domain prior to provision of the audio signal data to the trained microphone geometry assisted encoder model and prior to convolution with the predicted filter matrix.

15. A method according to claim 11, wherein the trained microphone geometry assisted encoder model comprises a U-net model.

16. A method according to claim 11, wherein the geometry data comprises a number of microphones and a location of respective microphones of the plurality of microphones.

17. A method according to claim 12, wherein a respective layer of the geometry encoder comprises a strided two dimensional (2D) convolution operation.

18. A method according to claim 11, wherein a respective layer of the signal encoder comprises at least two convolution operations with a respective convolution operation followed by a non-linear activation function, wherein the respective layer of the signal encoder further comprises a dropout function to generate a signal output from the respective layer.

19. A method according to claim 11, wherein a respective layer of the signal decoder comprises at least two convolution operations with a respective convolution operation followed by a non-linear activation function.

20. A method comprising:
providing geometry data related to a plurality of microphones of a microphone array and audio signal data to a microphone geometry assisted encoder model,
wherein the microphone geometry assisted encoder model comprises a geometry encoder configured to encode the geometry data and a signal encoder configured to encode the audio signal data,
wherein the geometry encoder and the signal encoder respectively comprise a plurality of layers and the microphone geometry assisted encoder model also comprises a plurality of connection links configured to connect respective layers of the geometry encoder and the signal encoder such that the signal encoder is configured to process both geometric data and audio signal data,
wherein the microphone geometry assisted encoder model further comprises a signal decoder comprising a plurality of layers and configured to generate an output, a plurality of connection links configured to connect respective layers of the signal encoder and the signal decoder, and a bottleneck connector between the signal encoder and the signal decoder; and
generating a predicted spatial audio signal based on the output of the microphone geometry assisted encoder model;
performing a comparison of the predicted spatial audio signal with a representation of a reference audio signal; and
training the microphone geometry assisted encoder model by modifying the microphone geometry assisted encoder model based upon the comparison.
